(19) United States
(12) Patent Application Publication
(10) Pub. No.: US 2015/0199582 A1
(43) Pub. Date: Jul. 16, 2015

(54) CHARACTER RECOGNITION APPARATUS AND METHOD

(71) Applicant: KABUSHIKI KAISHA TOSHIBA, Tokyo (JP)

(72) Inventors: Masayuki Okamoto, Kawasaki Kanagawa (JP); Kenta Cho, Kawasaki Kanagawa (JP); Kosei Fume, Kawasaki Kanagawa (JP)

(21) Appl. No.: 14/668,853

(22) Filed: Mar. 25, 2015

Related U.S. Application Data
(63) Continuation of application No. PCT/JP2013/076166, filed on Sep. 19, 2013.

(30) Foreign Application Priority Data
Sep. 26, 2012 (JP) 2012-213199

(51) Int. Cl. G06K 9/18

(52) U.S. Cl. CPC G06K 9/18

(57) ABSTRACT

According to one embodiment, a character recognition apparatus includes a first generation unit, an estimation unit, a second generation unit and a search unit. The first generation unit generates a user dictionary that a preferred character is registered. The estimation unit estimates a first separation between characters based on one or more of a layout of a target text and marking information. The second generation unit generates a lattice structure, by estimating character segments being expressed by strokes based on the first separation. The search unit searches, if the lattice structure includes the path corresponding to the preferred character, the lattice structure for a path to obtain a character recognition result.

### CROSS-REFERENCE TO RELATED APPLICATIONS

This application is a Continuation Application of PCT Application No. PCT/JP2013/076166, filed Sep. 19, 2013, and based upon and claiming the benefit of priority from Japanese Patent Application No. 2012-213199, filed Sep. 26, 2012, the entire contents of which are incorporated herein by reference.

### FIELD

Embodiments described herein relate generally to a character recognition apparatus and method.

### BACKGROUND

A handwritten character input scheme using, for example, a pen input, has widely been utilized. In accordance with development of not only personal digital assistant (PDA) terminals, but also smart phones, tablet computer, game machines, etc., the number of apparatuses with a pen input function is increasing.

Under these circumstances, users can easily create documents using intuitive input means that is obtained by electronically following a paper sheet and a pen. However, unlike the case of directly inputting text data using means such as a keyboard, a text or a character string of a document created by the above-mentioned input means cannot directly be searched for. In general, it is necessary to perform character recognition on a handwritten document in order to deal with the document as digital data.

When a handwritten character is input, in particular, in a free layout, enhancement in recognition accuracy is required. There is a method employed for a document in which printed characters and handwritten characters are mixed. This method includes discriminating the printed characters from the handwritten characters, then subjecting, to optical character recognition (OCR), the printed characters having relatively high recognition accuracy, and employing the OCR result if recognition candidates for handwritten characters are included in the OCR result. As a result, the recognition accuracy of handwritten characters can be enhanced.

### BRIEF DESCRIPTION OF THE DRAWINGS

FIG. 1 is a block diagram illustrating a character recognition apparatus;

FIG. 2 is a flowchart illustrating the operation of a user dictionary generation unit;

FIG. 3 is a view illustrating an example of an extraction process in the user dictionary generation unit;

FIG. 4 is a view illustrating an example of a user dictionary according to the embodiment;

FIG. 5 is a flowchart illustrating the operation of a character separation estimation unit;

FIG. 6 is a view illustrating an example of a detection and estimation process in the character separation estimation unit;

FIG. 7 is an example of a character type estimation process in the character separation estimation unit;

FIG. 8 is a flowchart illustrating the operations of a lattice generation unit and a lattice search unit;

FIG. 9 is a view useful in explaining the relationship between handwriting characters and strokes;

FIG. 10 is a view illustrating the relationship between character segments and stroke data;

FIG. 11 is a view illustrating an example of a lattice structure;

FIG. 12 is a view illustrating an example where character recognition processing is accurately performed; and

FIG. 13 is a view illustrating a character recognition result associated with target text data when the character recognition performed.

### DETAILED DESCRIPTION

When character recognition is performed on a handwritten document created on a page basis, if a line of a character string is simply detected and subjected to character recognition, a symbol (e.g. an index symbol “*” used for itemization) associated with the layout of a page may be mixed up with one stroke of a character. Further, regarding technical terms, such as the abbreviated names of departments of a company, company terms, and signs, the accuracy of character recognition will not be improved simply by applying a general N-gram or language model.

In general, according to one embodiment, a character recognition apparatus includes a first generation unit, an estimation unit, a second generation unit and a search unit. The first generation unit is configured to generate a user dictionary in which a character is registered as a preferred character, by extracting the character from at least one of text data items created by a user or used by the user. The estimation unit is configured to estimate a first separation between characters based on at least one of a layout of a target text and marking information, the target text being a text for a recognition processing, the marking information relating to a marking attached to the target text. The second generation unit is configured to generate a lattice structure, by estimating character segments which are expressed by strokes based on the first separation, the lattice structure being formed by the character segments and paths between the character segments and relating to a first character string included in a block providing the layout. The search unit is configured to, if the lattice structure includes a path corresponding to the preferred character, search the lattice structure for the path to obtain a character recognition result.

Referring now to the accompanying drawings, a character recognition apparatus, method and program according to an embodiment will be described in detail.

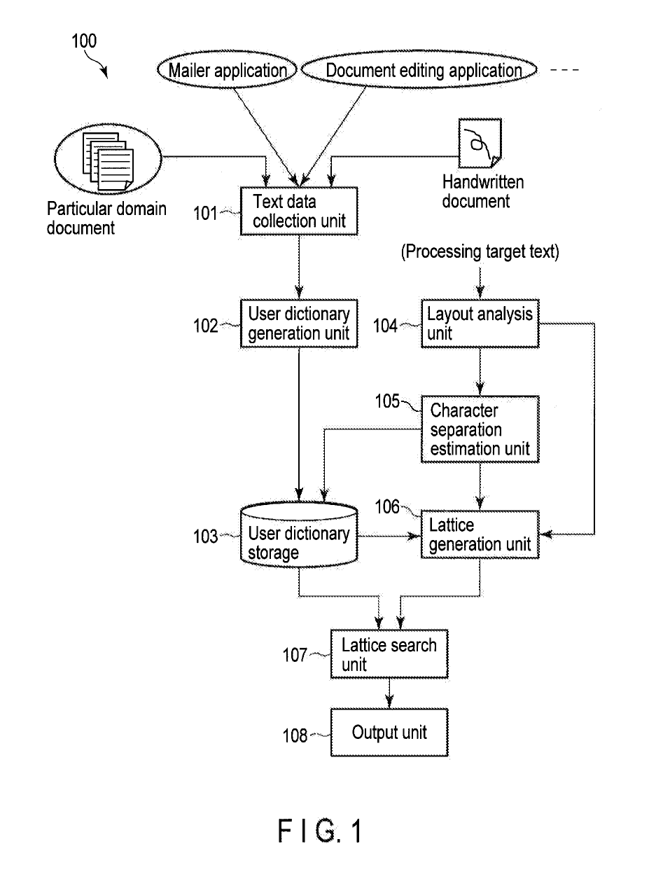

Referring to the block diagram of FIG. 1, the character recognition apparatus 100 of the embodiment will be described.

The character recognition apparatus 100 includes a text data collection unit 101, a user dictionary generation unit 102, user dictionary storage 103, a layout analysis unit 104, a character separation estimation unit 105, a lattice generation unit 106, a lattice search unit 107, and an output unit 108.

The text data collection unit 101 collects printed document data created by a user and printed document data utilized during browsing. Collection of these data items is performed using another apparatus or an application program. Namely, the printed document data includes a document created by using a mailer application, and that created by using a document editing application.

The text data collection unit 101 also collects printed document data included in a particular domain document, such as a business data. The particular domain document is a document utilized in an organization the user belongs to, or a field the user engages themselves in. This type of document contains terms the user often sees, regardless of whether they actually create or utilize the document. The terms contained in the particular domain document include, for example, the abbreviated names of departments, company terms and signs, and technical terms in the technical field. The text data collection unit 101 further collects document data handwritten by the user. The handwritten document data includes, for example, data input by handwriting using, for example, a pen device or a finger through a touch panel, handwriting data input in the form of an image by OCR processing, marking data, such as an underline or an encircling line made to text in printed document data, and data input in the form of comments on a margin. Hereinafter, printed document data and handwritten document data will collectively be referred to as text data, if not otherwise specified.

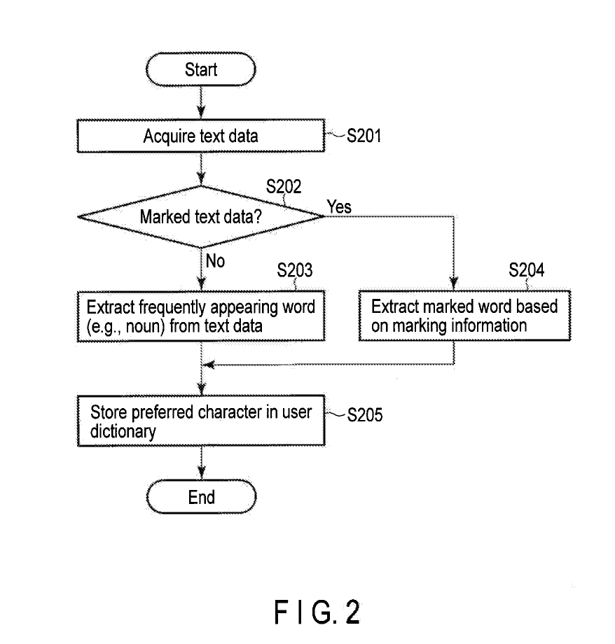

The user dictionary generation unit 102 receives one or more text data items from the text data collection unit 101 to extract a word and a symbol from a set of text data or printed document data included in a handwritten document, thereby generating a user dictionary in which the extracted word and symbol are registered as preferred characters. One of preferred characters is, for example, a character that appears in a document at high frequency. The process of generating the user dictionary will be described later with reference to FIG. 2.

The user dictionary storage 103 receives the user dictionary from the user dictionary generation unit 102, and stores it. The user dictionary storage 103 also receives a bullet character from the character separation estimation unit 105, described later, and stores it as a preferred character. The bullet character is a symbol associated with the page layout, and is, for example, an index symbol such as a midpoint “•”.

The layout analysis unit 104 externally receives text data as processing target, analyzes a target text data in association with ruling and lines, and extracts the layout analysis result and marking information indicating marks attached to the target text data. The target text data is a target of character recognition. Extraction of the layout analysis result and marking information is performed by, for example, estimating chart areas and character areas, and dividing the areas into lines, thereby analyzing marks made to the text. The extraction processing in the layout analysis unit 104 can be performed utilizing known stroke processing or OCR processing, and therefore will not be described in detail.

The character separation estimation unit 105 receives the layout analysis result, the marking information and target text data from the layout analysis unit 104, and estimates a bullet character and a symbol common in a plurality of lines to obtain an estimation result. The character separation estimation unit 105 may estimate the type of a character in a table, and include the estimated character type in the estimation result. The character type includes a Chinese character, a Japanese syllabary character, a number, an alphabet, etc.

The lattice generation unit 106 receives the estimation result and target text data from the character separation estimation unit 105, and receives the layout analysis result and marking information from the layout analysis unit 104. The lattice generation unit 106 estimates character segments expressed by strokes forming a character, and generates a lattice structure (also called a graph). The lattice structure indicates the coupling relationship between character segments, which is realized by character segments corresponding to a character itself or part of the character (e.g., “a left-hand radical” or “a right-hand radical”) and paths between the character segments.

The lattice search unit 107 receives the lattice structure from the lattice generation unit 106. The lattice search unit 107 refers to a preferred character stored in the user dictionary storage 103. If a path corresponding to the preferred character exists, the path is searched for and character recognition is performed to obtain a character recognition result.

The output unit 108 receives the recognition result from the lattice search unit 107, and outputs it to the outside.

Referring then to the flowchart of FIG. 2, a description will be given of the dictionary generation processing of the user dictionary generation unit 102.

At step S201, text data is acquired from the text data collection unit 101.

At step S202, it is determined whether or not the text data is the marked one, i.e., whether or not it is handwritten document data. If it is determined that the text data is not a marked one, i.e., if the text data is printed document data, the program proceeds to step S203, while if the text data is a marked one, the program proceeds to step S204. When handwritten document data is acquired, the entire printed document data may be acquired, only the page or paragraph in which handwriting data is input may be acquired, or only a character string that is limited by an underline or encircling line may be acquired. Alternatively, all text data may be acquired, and then only handwriting data be weighted.

At step S203, a frequently appearing word is extracted from the text data. As a frequently appearing word extraction method, morphological analysis, for example, is performed to extract a word appearing at high frequency or a word of a high score indicated by an index, such as Term Frequency-Inverse Document Frequency (TF-IDF). In this method, marking including a symbol or a rule mark input to text data by a user may be used as a clue to a bullet character and word separation.

At step S204, a word marked based on marking information is extracted.

At step S205, the frequently appearing word and the marked-up word acquired at steps S203 and S204 are stored as preferred characters in a user dictionary. This is the termination of the dictionary generating processing of the user dictionary generation unit 102.

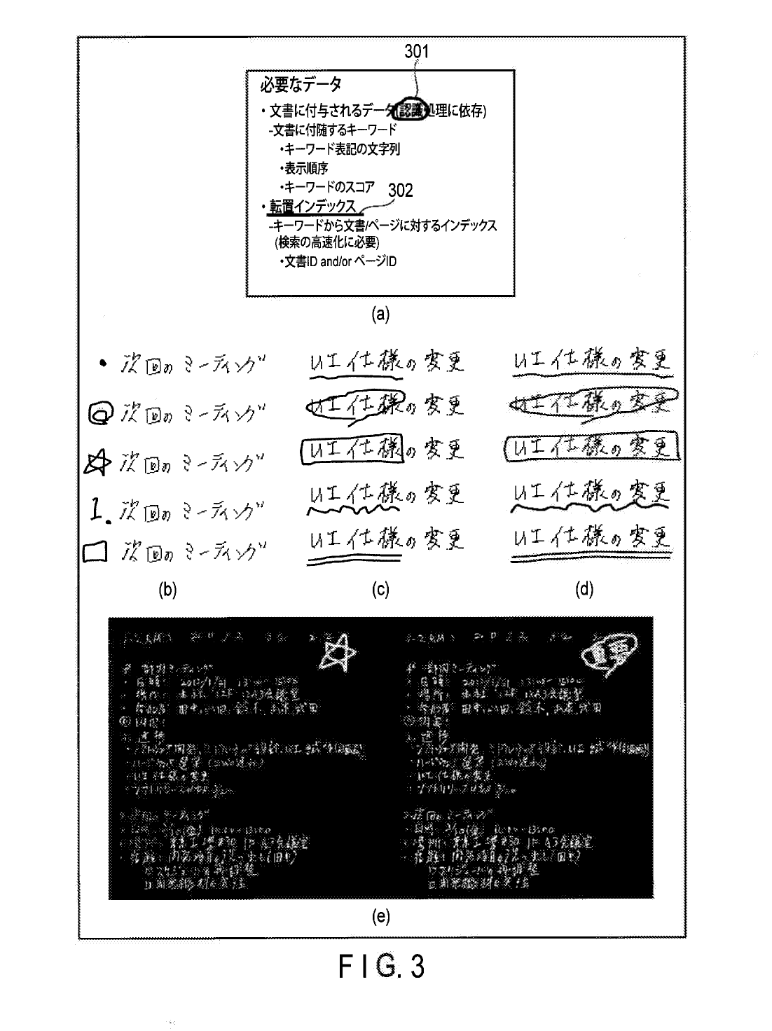

Referring then to FIG. 3, a description will be given of a specific example of extraction processing of a marked word at step S204.

FIG. 3 shows examples where words are extracted from text data that includes markings by a user.

In the example shown in (a) of FIG. 3, a marking 301 is made to encircle a word “ [symbol] (recognition),” and a marking 302 is made to underline words “ [symbol] (inverted index).” Since the user wishes to emphasize these words, the preference levels of the encircled character string and the underlined character string are set high.

As well as the underline and encircling line, markings include a mark to a bullet character or to the whole page. For instance, (b) of FIG. 3 shows examples where a header symbol exists at a line head. If there is a header symbol, such as a midpoint mark “•”, it is considered that this mark is effective for the subsequent character strings, and hence the whole character string included in the line beginning with the midpoint mark “•” is extracted. Namely, in the case of a line “ [symbol] [symbol] (• Next Meeting),” the words “ [symbol] [symbol] (Next Meeting)” are extracted as marked words.

(c) of FIG. 3 shows an example where part of a phrase is marked, i.e., the encircled or emphasized word is targeted. Specifically, if only words “UI [symbol] (UI specification),” are underlined as “ [symbol] (UI specification),” the words “UI [symbol] (UI specification)” are extracted as marked words.

(d) of FIG. 3 shows an example where the whole phrase is marked. In this case, the whole row is extracted as a marked phrase, as in the case of (a) of FIG. 3.

(e) of FIG. 3 shows examples where a mark is made to indicate the whole page. In this case, the whole page is an extraction target. Specifically, since a star mark “*” or a mark “ [symbol] (Important)” is attached at the upper right portion of the page, the whole sentences included in this page are extracted as marked words.

In the views of (b) to (e) of FIG. 3, handwriting marks are made to handwriting characters. Marking text data created by, for example, a document editing application may be treated in the same way as the above. Further, the range to be marked may be set arbitrarily. Namely, the range may be set to any arbitrary unit of a layout, such as, the whole or part of a paragraph or a chart.

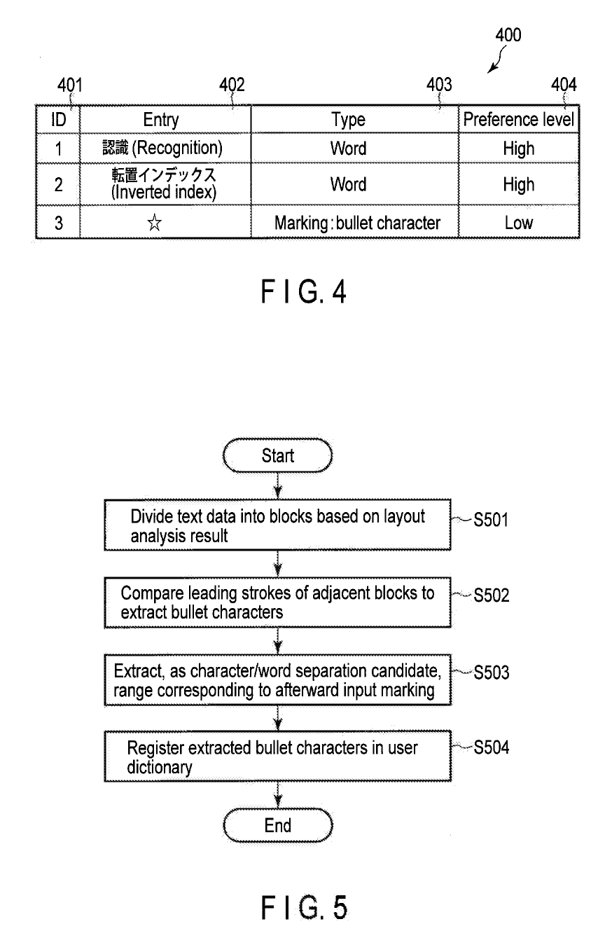

Referring to FIG. 4, a description will be given of an example of a user dictionary stored in the user dictionary storage 103.

A user dictionary 400 stores an ID 401, an entry 402, a type 403 and a preference level 404 in association with each other. The ID 401 is an identifier uniquely determined. The entry 402 indicates a preferred character. The type 403 indicates the attribute of the character as the entry 402. The preference level 404 indicates at what preference level the character is recognized in the user dictionary.

For instance, since the character “ [symbol] (recognition)” as the entry 402 is a word, “word” is input as the type 403, and this word is set “high” as the preference level 404 since it is extracted from handwritten document data. Further, assuming that the star mark “*,” which is input as the entry 402, indicates a mark used as a header at a line head, data “marking: bullet character” is set as the type 403 corresponding to the star mark “*.” Assuming that this mark is extracted from printed document data, the corresponding preference level 404 is set “low.”

Thus, since the user dictionary stores not only character strings but also bullet characters, the bullet characters can be discriminated from the character strings to thereby realize accurate recognition processing. Note that in the case of marking information, the entry cannot always be expressed as text data, other storage schemes, such as coordinates sequences or ID data indicating strokes or configuration, may be employed. In addition, although in FIG. 4, two preference levels, such as “high” and “low,” are employed, levels are not limited to this, but may employ any type of expression, such as a ten-stage numerical value expression. It is sufficient if the preference level can be measured.

Referring then to the flowchart of FIG. 5, the operation of the character separation estimation unit 105 will be described.

At step S501, text data as a processing target is divided into blocks, based on the layout analysis result of the layout analysis unit 104. The blocks are the layout elements of the text data as the processing target. Block division is determined based on, for example, the number of characters in one line, or on how the lines or the description ranges are close to each other.

At step S502, strokes in the leading portions of adjacent blocks are compared to thereby extract bullet characters. More specifically, the configurations or coordinates of some strokes in the leading portions of adjacent blocks are compared. If the configurations of the strokes in the leading portions are similar to each other and the strokes are arranged vertically or horizontally, the leading portions are extracted as bullet characters. The extracted bullet characters can be regarded as delimiters.

At step S503, the range corresponding to the marking input afterward is extracted as a character or word separation candidate. For instance, in (a) of FIG. 3, since a word “ [symbol] (recognition)” included in “ [symbol] (recognition process)” is encircled by a line, it can be estimated that the word “ [symbol] (recognition)” serves as a delimiter. In particular, when an original handwritten document is given as stroke data, an underline or encircling line can be utilized as a clue to estimation of an indicated word, since the lines can be determined to be those input afterward.

At step S504, the extracted bullet characters are registered in the user dictionary. This is the termination of the operation of the character separation estimation unit 105.

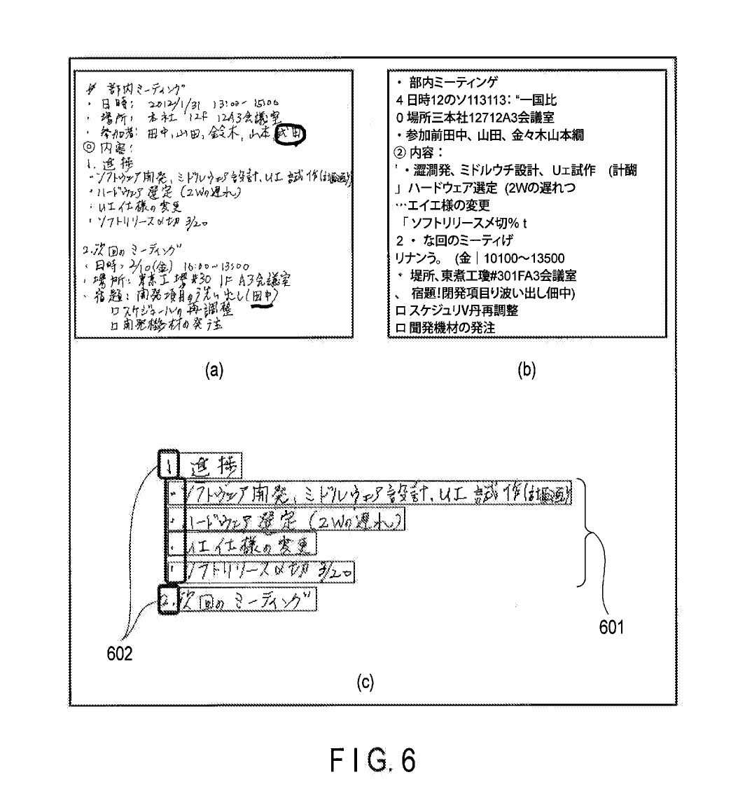

Referring then to FIG. 6, a description will be given of a specific example of processing performed by the character separation estimation unit 105 to detect bullet characters and words in the layout.

(a) of FIG. 6 shows handwritten target text data, and also shows a handwritten underline and encircling line.

(b) of FIG. 6 shows an example in which character recognition is performed in row units, using a conventional method. As shown in (b) of FIG. 6, bullet symbols “•” and “ ” are erroneously recognized as a different number or character, and Chinese characters “( [symbol] )” are erroneously recognized as “ [symbol] ).” If the user sees the image, they can instantly detect that a plurality of character strings are erroneously listed in the form of itemization. Thus, in the conventional processing performed in line units, it is strongly possible that a bullet character will be misidentified as another character or as one stroke included in a subsequent character.

(c) of FIG. 6 shows an example in which the character separation estimation unit 105 divides the layout into blocks based on the analysis result of the layout analysis unit 104, thereby estimating a bullet character and symbol common in a plurality of lines. More specifically, (c) of FIG. 6 shows estimation results of character strings recited in two stages.

Since bullet symbols “•” and “ ” can be estimated as bullet characters and/or symbols since they are recited in sequential lines. Further, since four sequential lines begin with “•,” these lines can be regarded as recitations beginning with the bullet symbol “•” 601.

Immediately before and after the four sequential lines beginning with the bullet symbol “•” 601, there are two lines beginning with “1” and “2.” These lines can be regarded as recitations beginning with a bullet character 602 including a number and a symbol “•” (full stop), Thus, it is understood that (c) of FIG. 6 shows recitations in two stages using the bullet characters 601 and 602. From this, it is estimated that these bullet characters and the body text are different types of characters. Using this estimation result, it can be determined that the bullet characters should be unified as the same character, and that the bullet characters should be separated from subsequent sentences by, for example, separating only the bullet characters from the respective segments before generating a lattice structure. As a result, character recognition accuracy can be enhanced.

Recitations arranged sequentially in, for example, an alphabetical order can be estimated in the same way as described above.

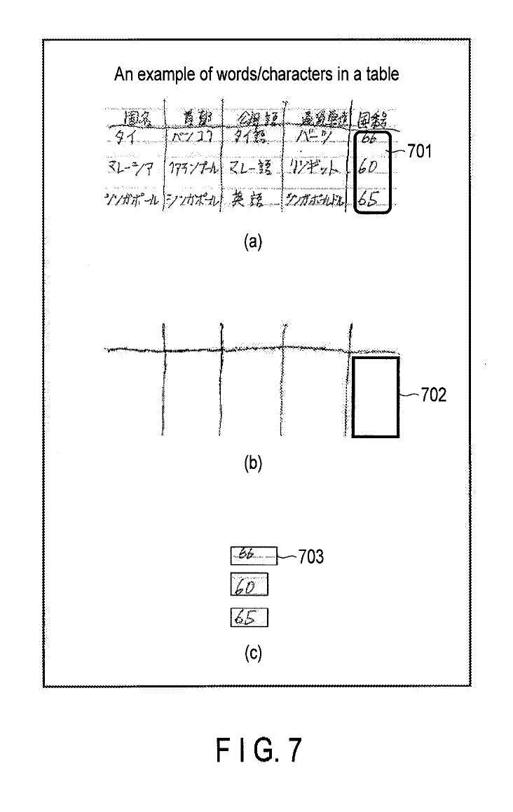

Referring to FIG. 7, a description will be given of character type estimation processing performed by the character separation estimation unit 105.

FIG. 7 shows an example in which the type of each character included in a handwritten table is estimated.

(a) of FIG. 7 shows an example of handwritten data arranged in a table.

Handwritten numbers are entered in the rightmost column 701 of the table. If data items of the same character type (alphabet, number, etc.) are sequentially entered in the same row or column, it is strongly possible that data of the same character type will be entered in another row or column.

(b) of FIG. 7 shows the layout analysis result of the layout analysis unit 104 concerning ruling. Areas partitioned by lines extending over a plurality of segments are estimated. A lower right area 702 is estimated to indicate one column or cell.

(c) of FIG. 7 is a view useful in explaining processing of estimating the character type of data entered in a block 703 included in the area 702 shown in (b) of FIG. 7. As shown in (c) of FIG. 7, the area 702 is divided into three blocks 703, and the data items in the blocks 703 are all numbers. If certain two characters are numbers, it is estimated that the other character may well be a number. Accordingly, when the lattice generation unit 106 generates a lattice structure, the character separation estimation unit 105 provides the lattice generation unit 106 with information for increasing the score that indicates the possibility of appearance of a number. As a result, the data items in subsequent blocks are likely to be recognized to be numbers.

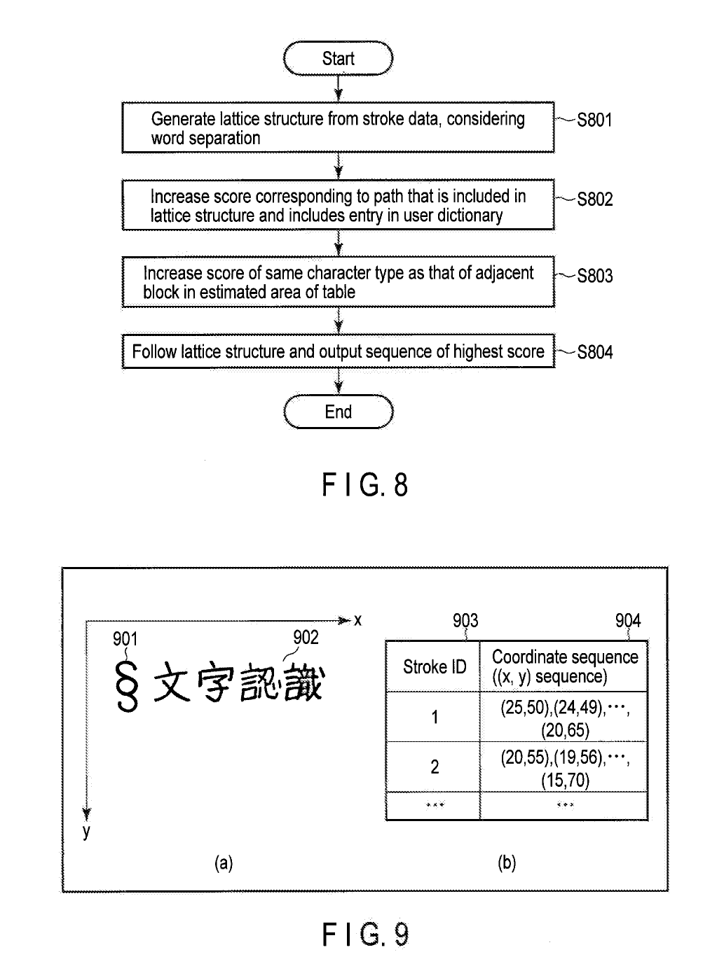

Referring to the flowchart of FIG. 8, character recognition processing performed by the lattice generation unit 106 and the lattice search unit 107 will be described.

As step S801, the lattice generation unit 106 generates a lattice structure from stroke data indicating strokes, in consideration of separations of words. More specifically, referring to the user dictionary produced at steps S501 to S504, the lattice structure is generated by estimating character segments in a character in association with a character area. Character segment estimation may be performed using an existing stroke/image processing method. Paths indicating the conjunction relationship between segments as parts of a character are added to the generated lattice structure, and weights corresponding to the paths are also added to the lattice structure.

As step S802, the lattice generation unit 106 performs character recognition processing based on the user dictionary and the lattice structure. The lattice generation unit 106 increases the score of the path that is included in the lattice and includes an entry or entries (preferred characters) in the user dictionary. More specifically, the lattice generation unit 106 detects whether or not the lattice includes a path that provides a word entered in the user dictionary. If the path is included, the score of the path is increased. To increase the score of the path, it is sufficient if a general method is used. Therefore, description of the method is omitted.

Alternatively, a method for causing a path including an entry (entries) in the user dictionary to be forcedly traced may be employed. Similarly, a method for extracting, as a keyword, an entry retrieved from the user dictionary, in addition to the character recognition result, may be employed.

At step S803, the lattice generation unit 106 increases the score of the same character type as that of an adjacent block in the estimated area of the table.

As step S804, the lattice search unit 107 follows the lattice structure, and outputs, as a character recognition result, a sequence of a high score that indicates the probability of appearance. This is the termination of the character recognition processing by the lattice generation unit 106 and the lattice search unit 107.

At steps S802 and S803, the same processing may be performed by the lattice search unit 107, instead of the lattice generation unit 106. This is the termination of the operation of the lattice generation unit 106 and the lattice search unit 107.

Referring now to FIG. 9, a relationship example between a handwritten character and strokes will be described.

(a) of FIG. 9 shows examples of handwritten character strokes. The block of this line includes a bullet character 901 “§” and words 902 “ [symbol] (character recognition).” Further, as stroke data, the corresponding table shown in (b) of FIG. 9 can be obtained. As shown in (b) of FIG. 9, stroke ID 903 and a coordinate sequence 904 are made to correspond to the data of FIG. 9(a). In the coordinate sequence 904, x- and y-coordinates are supposed. For instance, as the stroke data for the bullet character 901 “§,” coordinate sequence 904 associated with the x- and y-coordinates, “(25, 50), (24, 49), . . . , (20, 65),” is extracted. Thus, coordinate sequence data is acquired for each stroke. Namely, for each stroke, stroke ID corresponding to said each stroke, and the coordinate sequence providing said each stroke are extracted.

Referring to FIG. 10, the relationship between character segments included in a block and stroke data will be described.

FIG. 10 is a table showing the relationship between segment ID, a stroke ID sequence, and the type of each segment, acquired after character segments are estimated from a configuration of strokes. The table 1000 shown in FIG. 10 stores segment ID 1001, a stroke ID sequence 1002, and a type 1003, in association with each other.

The segment ID 1001 indicates a character string appearing in a block corresponding to a line.

The stroke ID sequence 1002 includes, based on the stroke data shown in (b) of FIG. 9, stroke IDs corresponding to the strokes necessary to form a character indicated by each segment ID.

The type 1003 indicates a character formed by strokes. For instance, the first two strokes (strokes 1 and 2) indicate a bullet character, and strokes 3 and 4 are used for segments “ [symbol] ,” “ [symbol] ” and “ [symbol] ” (these are Japanese characters). Namely, the strokes 3 and 4 serve as candidates for a plurality of characters. The stroke ID sequence 1002 may include other additional attribute data as in (b) of FIG. 9. Further, the method for estimating segments from a configuration of the strokes may employ general OCR search/check processing, or processing of searching and checking similar configurations based on similarity in vector sequence.

Referring to FIG. 11, an example of a lattice structure will be described.

FIG. 11 shows a lattice structure indicating the connection relationship between segments excluding bullet characters. A likelihood score (which is not shown for facilitating the description) is set between a certain segment and a segment that may follow. Based on the connection relationship and the weights between segments, character recognition processing is performed by tracing a path of a high likelihood. For example, there are two character candidates, such as a character segment 1102 “ [symbol] ” (a Japanese character) and a character segment 1103 “ [symbol] ” (a Japanese character different from the former), for character segments that may follow a character segment 1101 “ [symbol] .” In this case, a character segment is selected by selecting the one of paths 1104 and 1105 that has a higher score.

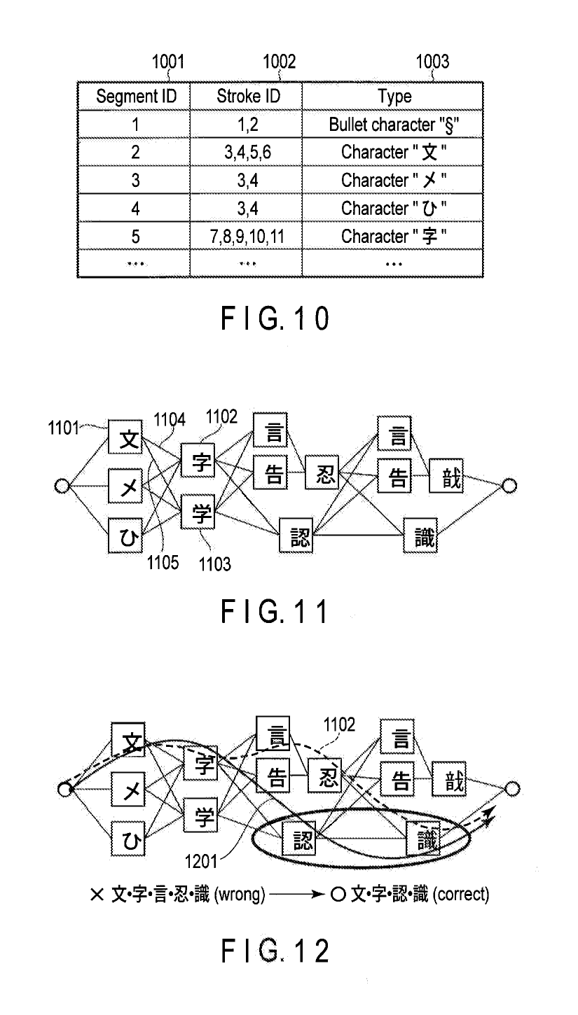

Referring to FIG. 12, a description will be given of an example where character recognition processing is correctly performed.

FIG. 12 shows an example of a lattice structure produced when a four-character term “ [symbol] ” is hand-written. This lattice structure includes an overall path 1201 corresponding to the four-character term “ [symbol] ( [symbol] + [symbol] + [symbol] + [symbol] )” (a correct processing result in this case), and an overall path 1202 corresponding to a five-character term “ [symbol] ( [symbol] + [symbol] + [symbol] + [symbol] + [symbol] ).” When a word “ [symbol] ( [symbol] + [symbol] )” is registered in the user dictionary, if the path in the lattice structure, which includes the word “ [symbol] [symbol] ,” is preferred, an appropriate recognition result can be output.

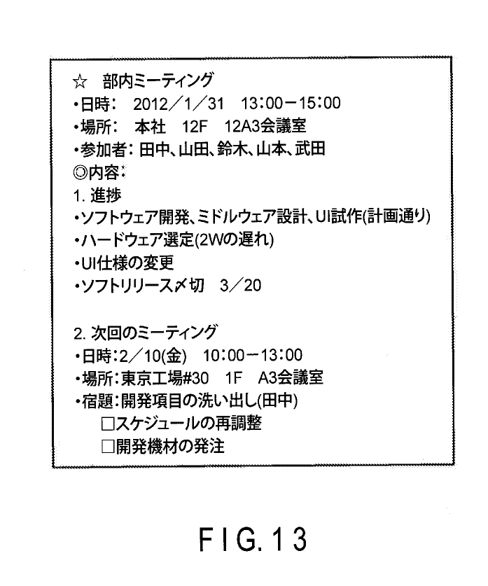

FIG. 13 shows the character recognition result of handwritten data in the embodiment.

More specifically, FIG. 13 shows the result of character recognition in the embodiment where the data shown in (a) of FIG. 6 is set as target text data. As shown in FIG. 13, an appropriate result, in which bullet characters and symbols are discriminated from adjacent characters, is output.

In the above-described embodiment, bullet characters or symbols and character separations are estimated based on a user dictionary in which user created or used text data is registered. As a result, even non-general terms, such as abbreviated expressions of the department names of a company, and technical terms in a particular field (e.g., terms used only in a company), can be recognized correctly, thereby reducing character recognition errors and enhancing character recognition accuracy.

The character recognition apparatus of the embodiment can be used in a terminal (such as a PC, a smart phone and a tablet) to which handwritten channel information can be input.

The text data collection unit 101, the user dictionary generation unit 102, the layout analysis unit 104, the character separation estimation unit 105, the lattice generation unit 106, and the lattice search unit 107 may be realized by a central processing unit (CPU) and a memory dedicated to the CPU. The user dictionary storage 103 may be realized by the memory dedicated to the CPU, or auxiliary storage.

The flow charts of the embodiments illustrate methods and systems according to the embodiments. It will be understood that each block of the flowchart illustrations, and combinations of blocks in the flowchart illustrations, can be implemented by computer program instructions. These computer program instructions may be loaded onto a computer or other programmable apparatus to produce a machine, such that the instructions which execute on the computer or other programmable apparatus create means for implementing the functions specified in the flowchart block or blocks. These computer program instructions may also be stored in a computer-readable memory that can direct a computer or other programmable apparatus to function in a particular manner, such that the instruction stored in the computer-readable memory produce an article of manufacture including instruction means which implement the function specified in the flowchart block or blocks The computer program instructions may also be loaded onto a computer or other programmable apparatus to cause a series of operational steps to be performed on the computer or other programmable apparatus to produce a computer programmable apparatus which provides steps for implementing the functions specified in the flowchart block or blocks.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A character recognition apparatus comprising:
a first generation unit configured to generate a user dictionary in which a character is registered as a preferred character, by extracting the character from at least one of text data items created by a user or used by the user;
an estimation unit configured to estimate a first separation between characters based on at least one of a layout of a target text and marking information, the target text being a text for a recognition processing, the marking information relating to a marking attached to the target text;
a second generation unit configured to generate a lattice structure, by estimating character segments which are expressed by strokes based on the first separation, the lattice structure being formed by the character segments and paths between the character segments and relating to a first character string included in a block providing the layout; and
a search unit configured to, if the lattice structure includes a path corresponding to the preferred character, search the lattice structure for the path to obtain a character recognition result.

2. The apparatus according to claim 1, further comprising an analysis unit configured to analyze, based on the target text, a figure including a line and ruling, and a marking information item related to markings which include an underline and a circling line.

3. The apparatus according to claim 1, wherein the first generation unit sets, at high, a preference level for a second character string included in a marked page in one of the text data items, and for a marked character string in the one of the text data items, and registers, in the user dictionary, the second character string and the marked character string, the second character string being one of the first character string, the preference level indicating a level with which each character is recognized in a preferred manner as the preferred character.

4. The apparatus according to claim 1, further comprising a collection unit configured to collect, through another application, the text data items included in a mail and a document created by the user.

5. The apparatus according to claim 4, wherein the collection unit is configured to collect the text data items from a particular domain document indicating a document that is used in at least one of an organization to which the user belongs, and a field in which the user engages.

6. The apparatus according to claim 1, wherein the estimation unit estimates a type of a character which has a possibility of being input based on the layout.

7. The apparatus according to claim 1, wherein the block is extracted from the layout of a text including a line, a figure and itemization.

8. The apparatus according to claim 1, wherein the preferred character includes a word and a bullet character being a symbol arranged at a top of a line.

9. The apparatus according to claim 8, wherein the first generation unit uses the marking as a clue to a second separation of the bullet character and the word, the marking including a symbol and ruling which input to the text data items by the user, the second separation being one of the first separation.

10. A character recognition method comprising:
generating a user dictionary in which a character is registered as a preferred character, by extracting the character from at least one of text data items created by a user or used by the user;
estimating a first separation between characters based on at least one of a layout of a target text and marking information, the target text being a text for a recognition processing, the marking information relating to a marking attached to the target text;
generating a lattice structure, by estimating character segments which are expressed by strokes based on the first separation, the lattice structure being formed by the character segments and paths between the character segments and relating to a first character string included in a block providing the layout; and
searching the lattice structure for a path to obtain a character recognition result if the lattice structure includes the path corresponding to the preferred character.

11. The method according to claim 10, further comprising analyzing, based on the target text, a figure including a line and ruling, and a marking information item related to markings which include an underline and a circling line.

12. The method according to claim 10, wherein the generating the user dictionary sets, at high, a preference level for a second character string included in a marked page in one of the text data items, and for a marked character string in the one of the text data items, and registers, in the user dictionary, the second character string and the marked character string, the second character string being one of the first character string, the preference level indicating a level with which each character is recognized in a preferred manner as the preferred character.

13. The method according to claim 10, further comprising collecting, through another application, the text data items included in a mail and a document created by the user.

14. The method according to claim 13, wherein the collecting the text data items collects the text data items from a particular domain document indicating a document that is used in at least one of an organization to which the user belongs, and a field in which the user engages.

15. The method according to claim 10, wherein the estimating the first separation estimates a type of a character which has a possibility of being input based on the layout.

16. The method according to claim 10, wherein the block is extracted from the layout of a text including a line, a figure and itemization.

17. The method according to claim 10, wherein the preferred character includes a word and a bullet character being a symbol arranged at a top of a line.

18. The method according to claim 17, wherein the generating the user dictionary uses the marking as a clue to a second separation of the bullet character and the word, the marking including a symbol and ruling which input to the text data items by the user, the second separation being one of the first separation.

19. A computer readable medium including computer executable instructions, wherein the instructions, when executed by a processor, cause the processor to perform a character recognition method comprising:
generating a user dictionary in which a character is registered as a preferred character, by extracting the character from at least one of text data items created by a user or used by the user;
estimating a first separation between characters based on at least one of a layout of a target text and marking information, the target text being a text for a recognition processing, the marking information relating to a marking attached to the target text;
generating a lattice structure, by estimating character segments which are expressed by strokes based on the first separation, the lattice structure being formed by the character segments and paths between the character segments and relating to a first character string included in a block providing the layout; and
searching the lattice structure for a path to obtain a character recognition result if the lattice structure includes the path corresponding to the preferred character.
